(19) United States
(12) Patent Application Publication
(10) Pub. No.: US 2009/0246550 A1
(43) Pub. Date: Oct. 1, 2009

(54) Tube

(76) Inventors: Carl-Johan Irander, Galve (SE); Goran Berglund, Sandviken (SE)

Correspondence Address: DRINKER BIDDLE & REATH (DC), 1500 K STREET, N.W., SUITE 1100, WASHINGTON, DC, 20005-1209, US

(21) Appl. No.: 12/083,625

(22) PCT Filed: Oct. 13, 2006
(86) PCT No.: PCT/SE2006/050400

§ 371 Date: Mar. 20, 2009

(30) Foreign Application Priority Data
Oct. 17, 2005 (SE) 0502312-2

(51) Int. Cl. B32B 1/08; C22C 38/44; C22C 38/50; B32B 1/04

(52) U.S. Cl. 428/586

(57) ABSTRACT

A thin walled tube is disclosed consisting essentially of a precipitation hardenable stainless steel and having a ratio, defined as outer tube circumference C divided by π times the square of the tube wall thickness w, of 90-350. The thin walled tube is highly suitable for use in sport appliance or furniture where weight and mechanical properties are of high importance.

The present invention relates to thin walled tube according to the preamble of claim 1.

Tube applications designed for low weight are today used in a vast number of applications within the areas of sport, rescue and safety equipment as well as various hand tools. These tubes are designed for low weight, stiffness and robustness during practical use. They should also be able to resist fatigue, corrosion and denting.

Lightweight tubes for these types of applications are mainly manufactured in materials with high specific stiffness (E-modulus/density) and strength (tensile strength/density) ratios. Examples of common materials are titanium and aluminum alloys as well as laminated fibers, e.g., glass and/or carbon fiber. Examples of the use of thin walled tubes in tennis rackets are disclosed in for example U.S. Pat. No. 3,975,017, U.S. Pat. No. 5,220,719 and US 2004/102,262; all using aluminum alloys.

As the density of the materials mentioned above is relatively low, the tubes need to be made with relatively thick walls, each material used in light weight applications being limited by its individual properties such as density, mechanical strength and ductility.

Traditionally used materials do however not provide a satisfactory solution to all the requirements of these applications, and there is a need for an alternative solution to the commonly used materials.

Consequently, the object of the invention is to provide a tube having sufficient mechanical properties at the same time as low weight, and which tube may be used in corrosive environments.

### SUMMARY OF THE INVENTION

The stated object is achieved by a thin walled tube as initially defined and having the features of the characterizing portion of claim 1.

The dimensions of the tube are carefully selected to give a high mechanical stability and strength at the same time as the weight is kept at a minimum.

The benefits of using the above identified precipitation hardenable stainless steel alloy as material in lightweight tube applications compared to aluminum and titanium alloys are inter alia lower weight, higher stiffness and considerably improved fatigue properties.

The thin wailed tube according to the present invention may have any conventional cross sectional geometry such as substantially circular, oval, square, rectangular, octagonal or peanut shaped.

In this context a thin wall is to be considered to be up to 3 mm.

### BRIEF DESCRIPTION OF THE DRAWINGS

FIG. 1 illustrates the specific stiffness, i.e. E-modulus/density, of an aluminum alloy, a titanium alloy, both commonly used in sport appliance, and a precipitation hardenable stainless steel used in the present invention.

FIG. 2 illustrates the specific strength, i.e. tensile strength/density, of an aluminum alloy, a titanium alloy, both commonly used in sport appliance, and a precipitation hardenable stainless steel used in the present invention.

FIG. 3 illustrates the tensile strength/E-modulus, of an aluminum alloy, a titanium alloy, both commonly used in sport appliance, and a precipitation hardenable stainless steel used in the present invention.

FIGS. 4a-e illustrate different cross sections of a tube in accordance with the invention.

FIG. 5 illustrates the use of a thin walled tube in accordance with the present invention in a tennis racket.

FIG. 6 illustrates the use of a thin walled tube in accordance with the present invention in furniture.

### DETAILED DESCRIPTION OF THE INVENTION

According to the present invention, a thin walled tube comprises a precipitation hardenable stainless steel alloy with the following composition in weight-%:

| | |
|---|---|
| C | max 0.07 |
| Si | max 1.5 |
| Mn | 0.2-5 |
| S | max 0.4 |
| Cr | 10-15 |
| Ni | 7-14 |
| Mo + 0.5 W | 1-8 |
| Cu | 1-3 |
| Ti | max 2.5 |
| Al | 0.1-1.5 |
| N | max 0.1 |

Balance Fe and normally occurring impurities.

In order to fully understand the influence of composition on the properties of the precipitation hardenable stainless steel alloy it is necessary to discuss all elements individually. All element contents are in weight percent.

Carbon is a powerful element that affects the steel in many ways. A high carbon content will affect the deformation hardening in such a way that the strength upon cold deformation will be high and thus reducing the ductility of the steel. A high carbon content could however be disadvantageous from corrosion point of view as the risk of precipitation of chromium carbides increase with increasing carbon content. The carbon content should therefore be kept low, max 0.07%, preferably max 0.05% and more preferably max 0.025%.

Silicon is a ferrite-forming element and may also in higher contents reduce the hot working properties of the steel. The content of Si should be limited to maximally 1.5% more preferably max 1.0%.

Manganese is an austenite-forming element that in a similar way as nickel makes the steel less prone to a martensitic transformation at cold deformation. The minimum content of manganese of the steel according to the invention is 0.2% by weight. As the steel has to have a significant content of martensite for the precipitation hardening the manganese content has to be max 5%, preferably max 3% and most preferably 2.5%.

Sulfur is an element that will form sulfides in the steel. Sulfides are beneficial during machining as they will act as chip-breakers. The content of sulfur is therefore preferably min 0.01% and more preferably min 0.015% and most preferably min 0.1%. Sulfides may however act as weak areas in the steel from a corrosion resistance point of view. Further, high contents of sulfur may also be detrimental for the hot working properties. The content should therefore be max 0.4% and preferably max 0.3%.

Chromium is essential for the corrosion resistance and must in the steel according to the invention be added in a content of at least 10% or more preferably at least 11.5%. Chromium is however also a strong ferrite former that in higher contents will suppress the martensite formation upon deformation. The content of chromium therefore has to be restricted to max 15%, preferably max 14%.

Nickel is added to the steel according to invention to balance the ferrite forming elements in order to obtain an austenitic structure upon annealing. Nickel is also an important element to moderate the hardening from cold deformation. Nickel will also contribute to the precipitation hardening together with elements such as titanium and aluminum. The minimum content of nickel is therefore 7% or more preferable at least 8%. A too high content of nickel will restrict the possibility to form martensite upon deformation. Nickel is also an expensive alloying element. The content of nickel is therefore maximized to 14 or preferably 13%.

Molybdenum is essential for the steel according to the invention, as it will contribute to the corrosion resistance of the steel. Molybdenum is also an active element during the precipitation hardening. The minimum content is therefore 1% or preferably, minimum 2% and most preferably minimum 3%. A too high content of molybdenum will however promote the formation of ferrite to a content that may result in problems during hot working. Further, a high content of molybdenum will also suppress the martensite formation during cold deformation. The content of molybdenum is therefore maximized to 6% and more preferable maximum 5%. Furthermore, it is expected that Mo could be partly or totally replaced by tungsten according to the common practice known to a person skilled in the art while still achieving the desired properties of the alloy.

Copper is an austenite former that together with nickel stabilizes the austenitic structure that is desired. Copper is also an element that increases the ductility in moderate contents. The minimum content is therefore 1% and more preferably at least 1.5%. On the other hand copper in high contents reduces the hot workability why the copper content is maximized to 3%, preferably maximum 2.5%.

Titanium can preferably be added to the alloy as it is a strong element for precipitation hardening and could therefore be present in order to be able to harden the steel to a desired final strength. However, too high titanium contents will promote ferrite formation in the steel and also increase the brittleness. The maximum content of titanium should therefore be restricted to 2.5% preferably 2% and most preferably not more than 1.5%.

Aluminum is added to the steel in order to improve the hardening effect upon heat treatment. Aluminum is known to form intermetallic compounds together with nickel such as Ni₃Al and NiAl. In order to achieve a good hardening response the minimum content should be 0.2% and preferably min 0.3%. Aluminum is however a strong ferrite former why the maximum content should be 1.5% or more preferably max 1.0%.

Nitrogen is a powerful element as it will increase the strain hardening as well as it will stabilize the austenite towards martensite transformation at cold forming. Nitrogen also has a high affinity to nitride formers such as titanium, aluminum and chromium. The nitrogen content should be restricted to maximum 0.1%, preferably 0.07% and most preferably max 0.05%.

The alloy used according to the invention is a precipitation hardenable stainless steel with an ultra high strength and a high E-modulus. Due to the high specific strength and stiffness of the alloy, thinner wall thickness can be utilized than with other materials. Still, a higher stiffness combined with low weight and a high loading capacity can be obtained, e.g., as assessed in a 3 point loading test.

Moreover, the alloy is suitable to be exposed to various mechanical treatments such as bending, stamping, polishing, shot peening or the like, depending on the final application of the tube and desired condition of appearance. The thin walled tube in accordance with the present invention can be produced in a cost effective manner for example by conventional metallurgical processes followed by traditionally used hot and cold forming processes to the desired final dimension. Moreover, since the surface of the alloy is suitable for grinding and polishing, a smooth surface can be accomplished. This is especially beneficial as the risk of initiation points for cracking being present on the surface of the alloy, is minimized. The same is valid for initiation points for localized corrosion attacks.

One specific example of the alloy used according to the invention is a precipitation hardenable stainless steel alloy with the following composition in weight-%:

| C | max 0.02 |
|---|---|
| Si | max 0.5 |
| Mn | max 0.5 |
| Cr | 12 |
| Ni | 9 |
| Mo | 4 |
| Cu | 2 |
| Ti | 0.9 |
| Al | 0.4 |

Balance Fe and normally occurring impurities.

The stability of a tube is influenced by the wall thickness and the outer dimension of the tube. Consequently, it is possible to express the stability by means of a ratio, hereinafter denominated Rwt, and defined by Equation 1, wherein C is the circumference and w is the wall thickness of the tube.

$$Rwt = \frac{C}{π {w}^{2}} . \qquad Equation 1$$

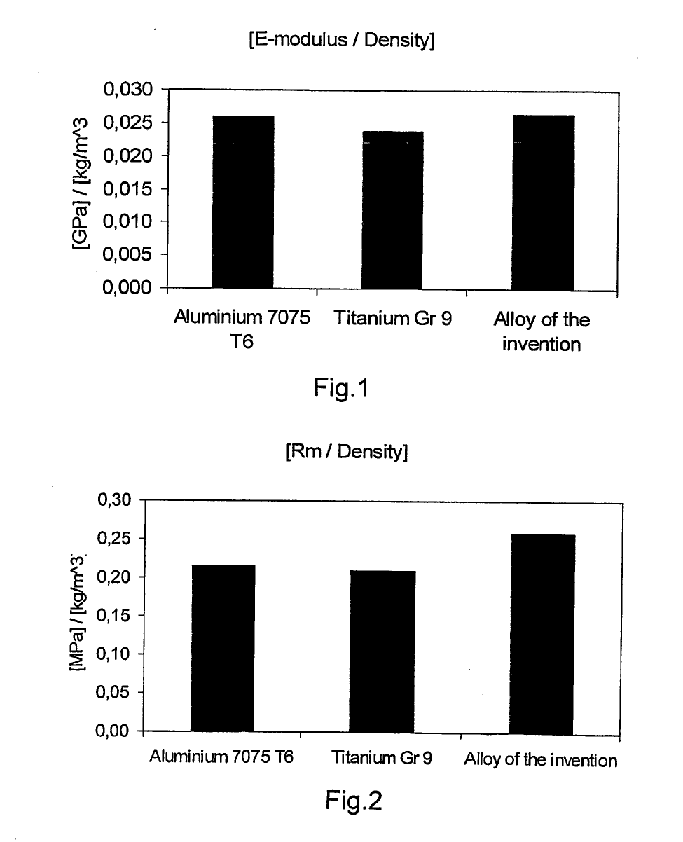

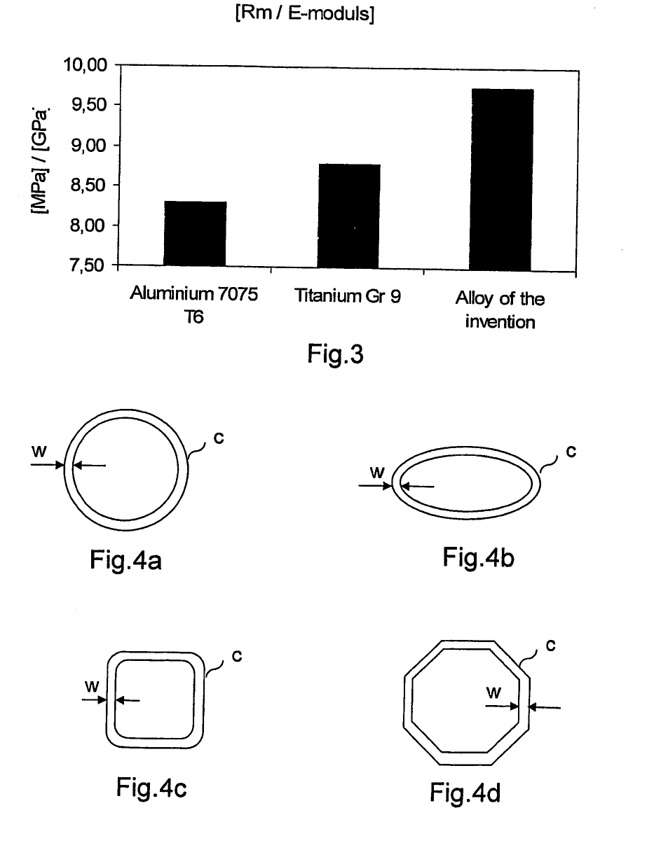

The thin walled tube according to the present invention has a ratio Rwt, as defined by Equation 1, of 90-350; and preferably 90-200. The ration Rwt is highly dependent on the material used. In order to illustrate this, the properties of the specific example of the alloy above is compared to an aluminum alloy and a titanium alloy, both commonly used in thin walled tubes for sport appliances such as shafts or handles for tennis rackets, in Table 1. This is also shown in FIGS. 1-3.

TABLE 1

| | | | Example of alloy used |
|---|---|---|---|
| | Aluminum | Titanium | according to the |
| Property | 7075 T6 | Gr 9 | invention |
| E-modulus [GPa] | 70 | 108 | 205 |
| Density [kg/m³] | 2700 | 4540 | 7800 |
| Poisson's ratio | 0.3 | 0.3 | 0.3 |
| Yield strength [MPa] | 528 | 850 | 1800 |
| Tensile strength [MPa] | 581 | 950 | 2000 |
| E-modulus/density | 0.026 | 0.024 | 0.026 |
| Yield strength/density | 0.196 | 0.187 | 0.231 |
| Tensile strength/ | 0.215 | 0.209 | 0.256 |
| density | | | |
| Yield strength/ | 7.54 | 7.87 | 8.78 |
| E-modulus | | | |
| Tensile strength/E- | 8.30 | 8.80 | 9.76 |
| modulus | | | |

If designing with aluminum, the wall thickness needs to be larger to compensate for the lower strength, which in turn results in a corresponding Rwt ratio from 10 to 40 to achieve a comparable stiffness when using the same outer dimension. The Rwt ratio for titanium alloys under the same conditions will range from 25 to 85.

Benefits of using the above identified precipitation hardenable stainless steel alloy as material in lightweight shaft application compared to aluminum and titanium alloys are inter alia lower weight, higher stiffness and considerably improved fatigue properties.

The properties of a tube can be optimized for the desired conditions by combining a geometrical design with a specific material to obtain suitable stiffness, loading capacity (strength) and weight. When designing a tubular section with a thin wall thickness to hold for an applied load, for example in a 3 point bending test, ovalisation, surface smoothness and buckling must also be considered. This is due to the loss of local strength and stability of a thin wall compared to a thicker wall section.

When overloading a tube with thick wall thickness and low ductility, resulting in a tubular section starting to buckle, it is likely that the localized strain in the buckled area will cause large areas cracking and thereby causing formation of sharp edges. Such sharp edges might for example cause damage such as harming a user of a tennis racket or the like. Lower levels of strains are likely to occur if thinner wall thicknesses are used. Consequently, the risk for a large drop in load capacity will be considerably less for a thin-walled tube than for a thicker-walled alternative due to the reduced risk of large strains within the areas of the buckle. Furthermore, when used in environments with low temperature, a thin walled tube according to the present invention has low thermal expansion and low thermal heat capacity compared to aluminum, thereby ensuring a minimum level of thermal introduced strain and a fast adoption to the surrounding temperature.

The alloy used according to the invention can be attached to other components or elements by any conventional method, such as welding, with adhesives or mechanical joints. The alloy has high corrosion resistance and is therefore suitable for use in for example humid environment applications, such as sport appliances for outdoor sports. The alloy does not need to be lacquered or otherwise protected against the outer surroundings/environment. However, if desired, the surface of the alloy may also be lacquered or painted if a special appearance is desired, such as a color. An excellent adherence of the lacquer can easily be accomplished.

According to an embodiment of the invention, the wall thickness of the tube is 0.1-1.5 mm depending on the intended application of the tube. Preferably, the thickness is less than 0.3 mm.

According to another embodiment of the invention, the tube has a mean outer diameter of 5-100 mm depending on the intended use of the tube, the mean diameter in this case being defined as the average value of the largest peripheral distance 1 and the smallest peripheral distance 2 of the cross section of the tube as indicated in FIG. 4e. Preferably, the outer diameter is equal or less than 50 mm.

As illustrated in FIGS. 4a-e, the thin walled tube according to the present invention may have any conventional cross sectional geometry such as substantially circular (FIG. 4a), oval (FIG. 4b), square (FIG. 4c), rectangular, octagonal (FIG. 4d) or peanut shaped (FIG. 4e). The wall thickness w and the circumference C is marked in the figures.

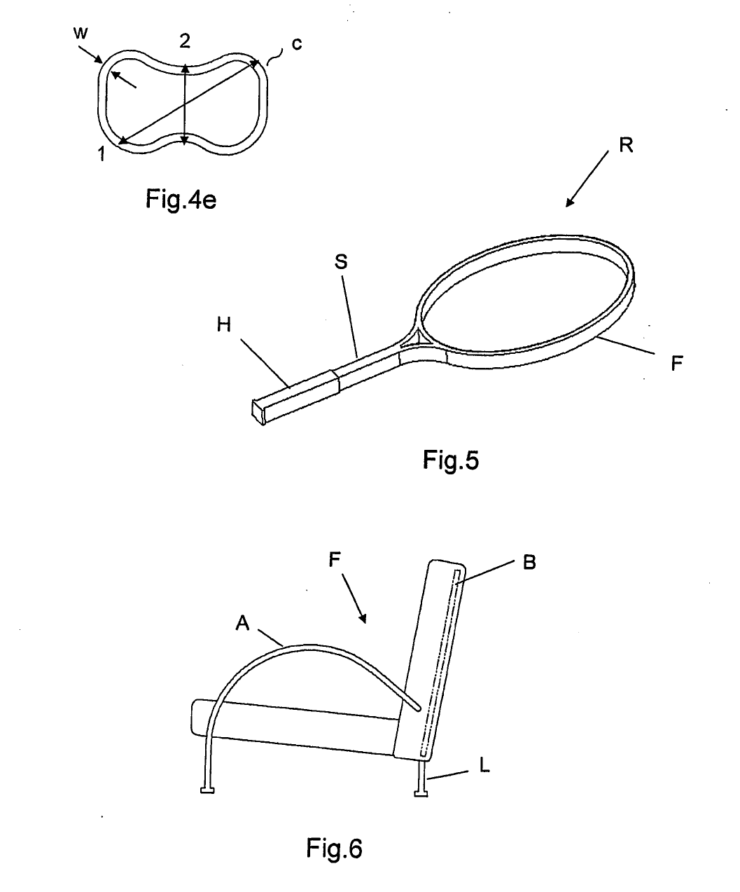

The thin walled tube according to the present invention is highly suitable for use in applications demanding high mechanical strength, low weight, esthetic appearance, and corrosion resistance. One example of such an application is in sport appliance such as rackets, baseball bats, ski poles, curling sticks or brooms, ice-hockey sticks, bicycle frames etc. FIG. 5 shows a tennis racket R wherein the thin walled tube may constitute the frame F, shaft S and/or handle H portion of the racket.

Another example of an application for the thin walled tube according to the invention is in furniture F as illustrated in FIG. 6. In this case the thin walled tube according to the invention may constitute a supporting structure, such as a leg L, an armrest A or a back B of a chair.

Yet another example of an application for the thin walled tube according to the present invention is in hand tools. One example of hand tools is garden tools, such as secateurs, rakes or spades. Other examples of hand tools are axes, ice axes, hammers, sledgehammers or iron-bar levers.

Furthermore, the tube according to the present invention is also suitable for use in means for transportation, such as wheel-chairs, sulkies and carts. These are all applications that inter alia might be frequently exposed to humid environments and consequently need to posses a high corrosion resistance.

### Example

A thin walled tube for use as a shaft in a badminton racket was designed, the tube consisting of a precipitation hardenable stainless steel with the following composition in percent by weight:

| C | max 0.02 |
|---|---|
| Si | max 0.5 |
| Mn | max 0.5 |
| Cr | 12 |
| Ni | 9 |
| Mo | 4 |
| Cu | 2 |
| Ti | 0.9 |
| Al | 0.4 |

Balance Fe and normally occurring impurities.

The wall thickness was designed to 0.25 mm and the outer diameter to 7 mm resulting in a Rwt of 112.

1. Thin walled tube having an inner circumference, a wall thickness (w) and an outer circumference (C) consisting essentially of a precipitation hardenable stainless steel alloy and having a ratio, defined as the outer circumference (C) divided by π times the square of the wall thickness (w), of 90-350.

2. Tube according to claim 1 wherein the alloy has the following composition in weight percent:

| | |
|---|---|
| C | max 0.07 |
| Si | max 1.5 |
| Mn | 0.2-5 |
| S | max 0.4 |
| Cr | 10-15 |
| Ni | 7-14 |
| Mo + 0.5 W | 1-8 |
| Cu | 1-3 |
| Ti | max 2.5 |
| AI | 0.1-1.5 |
| N | max 0.1 |

balance Fe and normally occurring impurities.

3. Tube according to claim 1 wherein the wall thickness (w) is less than 3 mm.

4. Tube according to claim 1 wherein the tube has a mean outer diameter of 5 to 100 mm.

5. Tube according to claim 1 wherein the material is precipitation hardened.

6. Thin walled tube according to claim 1 wherein the tube has a substantially circular or octagonal cross section.

7. Thin walled tube according to claim 1 wherein the tube has a substantially oval, square, rectangular, or peanut shaped cross section.

8. Sport appliance comprising a thin walled tube according to claim 1.

9. Sport appliance according to claim 8 wherein the thin walled tube is in the form of a shaft (S), handle (H), frame (F), or crossbar.

10. Furniture comprising a thin walled tube according to claim 1.

11. Furniture according to claim 10 wherein the thin walled tube is in the form of a supporting structure.

12. Hand tool comprising a thin walled tube according to claim 1.

13. Means for transportation comprising a thin walled tube according to claim 1.

14. Tube according to claim 3 wherein the wall thickness (w) is 0.1 to 1.5 mm.

15. Furniture according to claim 10, wherein the furniture is a chair or a sofa.

16. Furniture according to claim 11, wherein the supporting structure is a leg (L), an armrest (A) or a back (8) of a chair.
